(19) United States
(12) Patent Application Publication
(10) Pub. No.: US 2011/0212305 A1
(43) Pub. Date: Sep. 1, 2011

(54) TRANSPARENT CONDUCTIVE LAMINATE COMPRISING VISUAL LIGHT ADJUSTMENT LAYERS

(75) Inventors: HSUAN TA CHEN, HSINCHU HSIEN (TW); MING HONG HSU, HSINCHU HSIEN (TW); CHUN KUANG LAI, HSINCHU HSIEN (TW)

(73) Assignee: USHINE PHOTONICS CORPORATION, HSINCHU HSIEN (TW)

(21) Appl. No.: 13/027,510

(22) Filed: Feb. 15, 2011

(30) Foreign Application Priority Data
Feb. 26, 2010 (TW) 099105560

(51) Int. Cl. B32B 7/02; B32B 9/04; B32B 5/00; B32B 3/30

(52) U.S. Cl. 428/172; 428/411.1; 428/212; 428/702; 428/697; 428/337; 428/336; 428/216; 428/426; 428/696

(57) ABSTRACT

A transparent conductive laminate includes an organic polymer transparent substrate, a first visual light adjustment layer, a second visual light adjustment layer, a third visual light adjustment layer, and a transparent conductive layer. The first visual light adjustment layer has a refractive index of from 1.3 to 1.7 and an optical thickness of from 10 nanometers to 260 nanometers. The second visual light adjustment layer has a refractive index of from 1.8 to 2.5 and an optical thickness of from 3 nanometers to 1500 nanometers. The third visual light adjustment layer has a refractive index of from 1.3 to 1.7 and an optical thickness of from 10 nanometers to 260 nanometers. The root mean square deviation between the reflectance value over the wavelength range of from 380 nm to 700 nm and the average reflectance value over the wavelength range of from 380 nanometers to 700 nanometers is below 3%. The surface resistance of the transparent conductive laminate ranges from 130 to 1000Ω/cm².

### BACKGROUND OF THE INVENTION

1. Field of the Invention

The present invention relates to a transparent conductive laminate that is transparent or translucent to visible light, and more particularly related to transparent conductive laminate comprising visual light adjustment layers.

The transparent conductive laminate comprising visual light adjustment layers can be used for a liquid crystal display, an electroluminescent display, an anti-static film, or an EMI (electric magnetic interference) shielding film, and more specifically, for projected capacitive touch panel or modified resist touch panel.

2. Description of the Related Art

The rapid development in electronic and information technologies facilitates the miniaturization of electronic products. Touch panels provide users with basic touch buttons and simple virtual user interface features such as a scroll control feature. The technology of touch panels can provide a situational user interface solution, facilitating the miniaturization and simplifying the user interface of devices, and providing a new industrial design. Because touch panel technology allows users to instinctively input commands and manipulate electronic products, the interaction between users and electronic products is changed. As such, touch panels are popularly applied in different electronic products, especially in automobile electronic products.

According to location detecting principles, there are resistive type touch panels, capacitive type touch panels, infrared type touch panels, and electromagnetic induction type touch panels, wherein the resistive type touch panels and the capacitive type touch panels are most popular in the market. In particular, projected capacitive touch panels have a feature that can detect multi-touch input. Users can simultaneously input commands and manipulate images using fingers. Thus, the projected capacitive touch panels have become a focus of development in recent years.

A projected capacitive touch panel is manufactured by bonding two glass substrates each having an etched, patterned transparent conductive layer (TCL). Because the production yield of bonding two glass substrates is low, the amount of material waste is very high, especially when the middle-sized and large-sized glass substrates are bonded.

Alternatively, a projected capacitive touch panel can use a single substrate having two transparent conductive layers. The transparent conductive layers can be formed on the same surface or separately on opposite surfaces. However, a single substrate having two transparent conductive layers requires complex etching processes and has a complex wire layout.

In order to solve the above problem, transparent plastic substrates are adopted instead of glass substrates to achieve better production yield and to simplify manufacturing processes. However, due to limitations of the low glass transition temperature (Tg) of plastic substrates and the lower transmittance of plastic substrates compared to that of glass substrates, a high temperature film formation process cannot be applied to obtain a transparent conductive layer with better quality. In particular, a TCL with low surface resistance (below 200Ω/cm²) is employed for better operation sensitivity, signal-to-noise ratio, and reliability. Such a TCL has a greater thickness, which may deteriorate the entire transmittance. Furthermore, when a thick TCL is patterned, the difference between the hue before the TCL is patterned and the hue after the TCL is patterned is significant, severely degenerating the optical characteristics of the touch panel.

Currently, a conventional method is to add one or two buffer layers between a TCL and a plastic substrate to reduce the reflectance of the substrate and to improve the transmittance of the substrate. However, after the TCL is patterned, such a patterned TCL exhibits sufficiently great hue difference between the pattern portion and the hollow portion while light is transmitted through or reflected from the substrate. In particular, when a TCL with low surface resistance (below 200Ω/cm²) is employed, one or two buffer layers still cannot sufficiently compensate for the hue difference between the pattern portion and the hollow portion. As a result, users can still clearly see the etched TCL pattern. The image quality of a touch control display is severely affected.

To normal human eyes, if the hue difference between the pattern portion and the hollow portion is desired to be undetected, the chromatic aberration factors Δa* and Δb* have to be made as small as possible, for example, below 1.0 by experience (a* and b* are coordinate values of the CIE L*a*b* system originated in 1976). Moreover, it is preferable to minimize the average reflectance difference ΔRₐᵥₑ between the pattern portion and the hollow portion. In general, ΔRₐᵥₑ must be less than 3.0%, a level at which the borders of the patterned TCL pattern cannot be easily detected.

In view of above, the touch panel manufacturers need to provide a transparent conductive laminate with improved structure so as to resolve the aforesaid problems of present flexible transparent conductive laminates that are currently applied to the capacitive or modified resistant touch panels.

### SUMMARY OF THE INVENTION

The present invention provides a transparent conductive laminate. The invention can particularly be embodied as a transparent conductive laminate with low surface resistance (below 200Ω/cm²) as shown in FIG. 1. There are three visual light adjustment layers interposed between a transparent substrate and a TCL so the light with wavelengths from 380 nm to 700 nm transmitting the transparent conductive laminate has small variation, and the average of reflectance is low. Accordingly, the differences Δa* and Δb* between the hues of TCL pattern portions and hollow portions can be limited under 1.0. Moreover, the unpatterned transparent conductive laminate has a superior VLT (visual light transmittance) of less than 86%.

In accordance with an embodiment of the present invention, a transparent conductive laminate comprising an organic polymer transparent substrate, a first visual light adjustment layer, a second visual light adjustment layer, a third visual light adjustment layer, and a transparent conductive layer. The refractive index of the first visual light adjustment layer ranges from 1.3 to 1.7, and its optical thickness ranges from 10 nm to 260 nm; the refractive index of the second visual light adjustment layer ranges from 1.8 to 2.5, and its optical thickness ranges from 3 nm to 1500 nm; the refractive index of the third visual light adjustment layer ranges from 1.3 to 1.7, and its optical thickness ranges from 10 nm to 260 nm. The transparent conductive layer has a refractive index of from 1.8 to 2.2, and an optical thickness of from 10 nm to 220 nm.

To better understand the above-described objectives, characteristics and advantages of the present invention, embodiments, with reference to the drawings, are provided for detailed explanations.

### BRIEF DESCRIPTION OF THE DRAWINGS

The invention will be described according to the appended drawings in which:

FIG. 1 shows a schematic cross-sectional diagram of a transparent conductive laminate in accordance with an embodiment of the present invention;

FIG. 2 shows a schematic cross-sectional diagram of a transparent conductive laminate in accordance with an embodiment of the present invention;

FIG. 3 shows a plot of the reflectance R₁(λ) at the pattern portions and the reflectance R₂(λ) at the hollow portions as shown in FIG. 2 vs. wavelengths according to one embodiment of the present invention; and

FIG. 4 shows a schematic cross-sectional diagram of a transparent conductive laminate in accordance with another embodiment of the present invention.

### DETAILED DESCRIPTION OF THE INVENTION

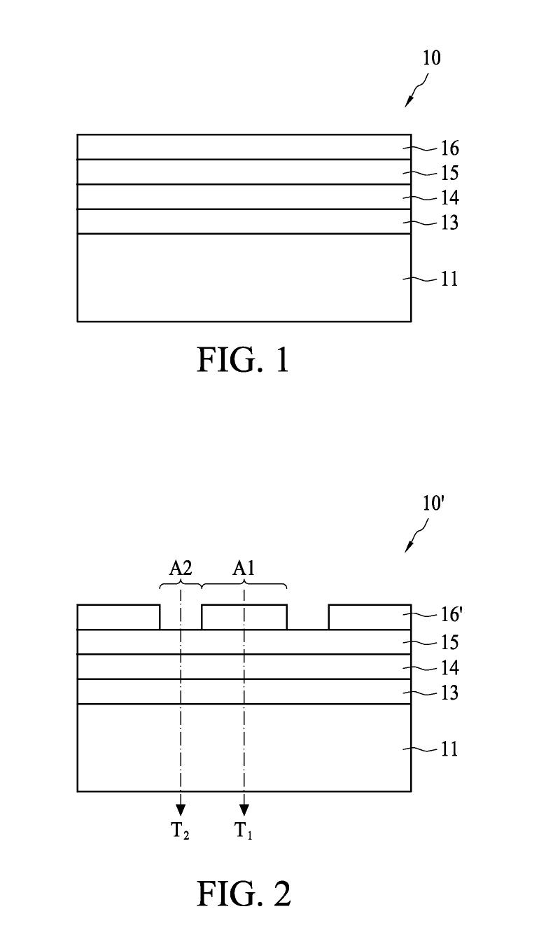

As shown in FIG. 1, the present invention discloses a transparent conductive laminate 10 comprising an organic polymer transparent substrate 11, a first visual light adjustment layer 13, a second visual light adjustment layer 14, a third visual light adjustment layer 15, and a transparent conductive layer 16.

FIG. 2 shows a schematic cross-sectional diagram of a transparent conductive laminate in accordance with an embodiment of the present invention. Compared with the transparent conductive laminate 10 of FIG. 1, the transparent conductive laminate 10′ is etched to form a transparent conductive layer 16′ as shown in FIG. 2 comprising the portions A1 with the TCL and the portions A2 without the TCL, and lights T₁ and T₂ are respectively transmitted through the two portions A1 and A2.

The refractive indices and thicknesses of the three visual light adjustment layers 13 to 15 can be adjusted to achieve the following objectives: (A) The root mean square deviation ΔRᵣₘₛ between the reflectance R(λ) of the transparent conductive laminate over a wavelength range of from 380 nm to 700 nm and the average reflectance Rₐᵥₑ of the transparent conductive laminate 10 over a wavelength range of from 380 nm to 700 nm is below 3%, preferably below 2.0%, and more preferably below 1.0%. The root mean square deviation ΔRᵣₘₛ can be obtained by the following formula (1):

$$Δ {R}_{rms} = \sqrt{\frac{{\int }_{λ = 380}^{700} {( R ( λ ) - {R}_{ave} )}^{2} d λ}{( 700 - 380 )}} \\ where {R}_{ave} = \frac{{\int }_{λ = 380}^{700} R ( λ ) d λ}{( 700 - 380 )} \qquad ( 1 )$$

is the average reflectance Rₐᵥₑ over a wavelength range from 380 nm to 700 nm.

(B) The average of the reflectance difference ΔRₐᵥₑ between the pattern portions and the hollow portions is below 3.0%, preferably below 2.0%, and most preferably below 1.0%. For example, the reflectance of the pattern portions A1 and the hollow portions A2 (as shown in FIG. 2) respectively represented by R₁(λ) and R₂(λ), and the ΔRₐᵥₑ can be obtained by the following formula (2):

$$Δ {R}_{ave} = \frac{{\int }_{λ = 380}^{700} \vert {R}_{1} ( λ ) - {R}_{2} ( λ ) \vert d λ}{( 700 - 380 )} \qquad ( 2 )$$

In general, as the thickness of the TCL is increased, the surface resistance and the transmittance thereof are accordingly decreased. As a result, the TCL looks more yellowish. If the surface resistance is lowered below 200Ω/cm² (in such a case, the thickness of the TCL is generally greater than 25 nm), the reflectance difference between the pattern portions A1 and the hollow portions A2 cannot be ignored even if a conventional single buffer layer or two buffer layers are added, or if a conventional low reflective design is utilized.

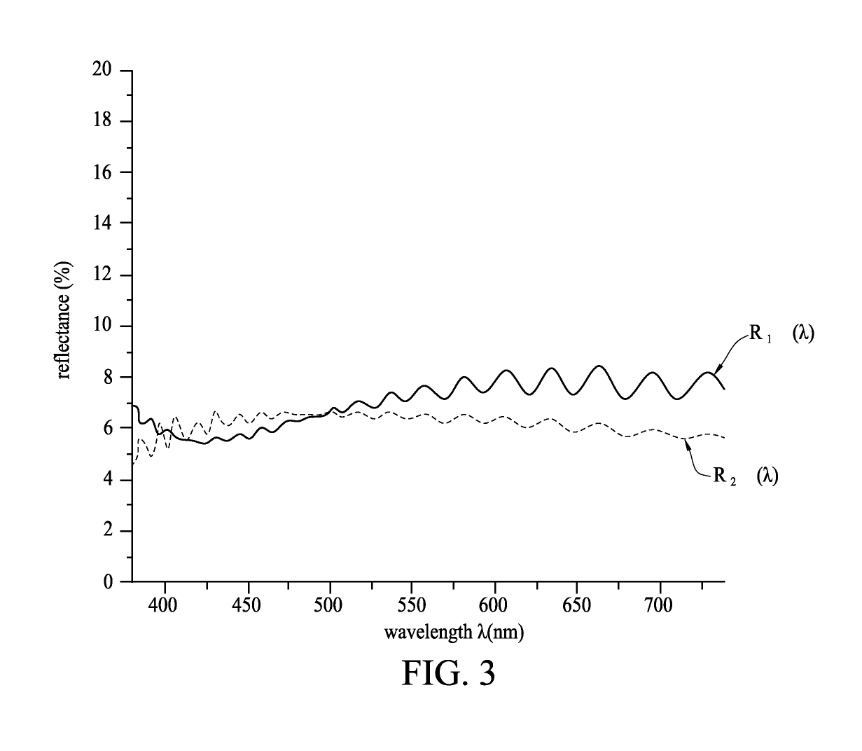

The transparent conductive laminate of the present invention utilizes three visual light adjustment layers to work with a TCL layer, and can be widely applied to transparent conductive laminates with surface resistance below 200Ω/cm², and even below 130Ω/cm². First, the concept of the present invention is to adjust the reflective light spectrum of the transparent conductive laminate with visual light adjustment layers to a smooth curve, the root mean square deviation of which ΔR₁ is below 3.0% over the visible wavelength range. That is, the transparent conductive laminate has clearer and more transparent hues over the wavelengths of visual light ranging from 380 nm to 700 nm, and exhibits no obvious color shifts (i.e. a* and b* approach 0). When the transparent conductive laminate is patterned, among the visual light wavelengths ranging from 380 nm to 700 nm, the reflectance difference ΔR(A)=R₁(λ)−R₂(λ) is not apparent, as shown in FIG. 3. Consequently, the ΔRₐᵥₑ can be less than 3%, and human eyes cannot sense the hue difference between the portions A2 without TCL and the pattern portions. FIG. 3 shows a plot of the reflectance R₁(λ) at the pattern portions and the reflectance R₂(λ) at the portions without TCL as shown in FIG. 2 vs. wavelengths according to one embodiment of the present invention.

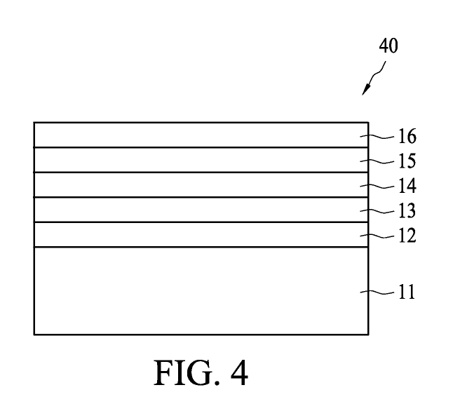

Referring to FIG. 4, another embodiment of the present invention discloses a transparent conductive laminate 40, which further comprises a medium layer 12. The medium layer 12 can be an organic, inorganic, or metal oxide layer, and can be disposed between the organic polymer transparent substrate 11 and the first visual light adjustment layer 13. As shown in FIG. 4, the medium layer 12 is used for enhancing the attachment of the first visual light adjustment layer 13 to the organic polymer transparent substrate 11, having a physical thickness of below 10 nanometers, preferably in a range of 2 to 5 nanometers. The medium layer 12 may comprise carbon, silicon, aluminum oxide (Al₂O₃), or SiOₓ, where x=1 to 2. Due to the low thickness of the medium layer 12, the medium layer 12 can enhance the attachment of the first visual light adjustment layer 13 to the organic polymer transparent substrate 11 while not adversely affecting the optical property of the transparent conductive laminate 40.

### Organic Polymer Transparent Substrate

The organic polymer transparent substrate 11 can be a transparent flexible plastic substrate with a refractive index of from 1.4 to 1.7. The material of the organic polymer transparent substrate 11 can be polyethylene terephthalate (PET), polyethylene (PE), polyarylate (PAR), polyether sulfone (PES), poly(methyl methacrylate) (PMMA), polyethylene naphthalate (PEN), or polycarbonate (PC). The thickness of the organic polymer transparent substrate 11 can be in a range of from 2 to 250 micrometers. If the thickness of the organic polymer transparent substrate 11 is less than 2 micrometers, the organic polymer transparent substrate 11 may not have sufficient mechanical strength to allow the visual light adjustment layers and TCL to be formed thereon. If the thickness of the organic polymer transparent substrate 11 is greater than 250 micrometers, the touch panel including the organic polymer transparent substrate 11 cannot be lightweight. The organic polymer transparent substrate 11 can have a harden layer formed on one surface thereof, or two harden layers separately formed on two surfaces thereof. The harden layer may be made of silicon derived resins, acrylics derived resins, urethane derived resins, or alkyd derived resins. The organic polymer transparent substrate 11 can exhibit a haze ranging from 0.2% to 10%. If the organic polymer transparent substrate 11 has a lower haze, the organic polymer transparent substrate 11 is clearer and more transparent; if the organic polymer transparent substrate 11 has a higher haze, the organic polymer transparent substrate 11 is transparent while having effectiveness in eliminating Newton ring and glare.

### First Visual Light Adjustment Layer

The first visual light adjustment layer 13 can have a refractive index in a range of from 1.3 to 1.7, and can be made of organic material, inorganic material, or a mixture of organic and inorganic material. The first visual light adjustment layer 13 may comprise sodium fluoride (NaF), lithium fluoride (LiF), magnesium fluoride (MgF₂), silicon dioxide (SiO₂), or aluminum oxide (Al₂O₃). The optical thickness of the first visual light adjustment layer 13 can be in a range of from 10 nanometers to 260 nanometers. The first visual light adjustment layer 13 can be formed using a wet-coating process, a sputtering process, a vapor chemical deposition process, a plasma ion deposition process, or a plasma chemical vapor deposition process.

### Second Visual Light Adjustment Layer

The second visual light adjustment layer 14 can have a refractive index in a range of from 1.8 to 2.5, and comprise cerium oxide (CeO₂), titanium dioxide (TiO₂), niobium pentoxide (Nb₂O₅), zirconium dioxide (ZrO₂), or tantalum pentoxide (Ta₂O₅). The second visual light adjustment layer 14 can have an optical thickness in a range of from 3 nanometers to 150 nanometers, and be formed using a sputtering process, a vapor chemical deposition process, a plasma ion deposition process, or a chemical vapor deposition process.

### Third Visual Light Adjustment Layer

The third visual light adjustment layer 15 may have a refractive index in a range of from 1.8 to 2.5, comprise sodium fluoride (NaF), lithium fluoride (LiF), magnesium fluoride (MgF₂), silicon dioxide (SiO₂), or aluminum oxide (Al₂O₃), and can be formed using a wet-coating process, a sputtering process, a vapor chemical deposition process, a plasma ion deposition process, or a plasma chemical vapor deposition process.

### Transparent Conductive Layer

The transparent conductive layer 16 may have a refractive index in a range of from 1.8 to 2.2, comprise transparent metal oxide semiconductor such as indium tin oxide (ITO), indium zinc oxide (IZO), aluminum zinc oxide (AZO), or antimony-doped tin oxide (ATO), have an optical thickness in a range of from 10 nanometers to 220 nanometers, and be formed using a sputtering process, a plasma ion deposition process, or a chemical vapor deposition process.

### Medium Layer

The medium layer 12 can be an inorganic compound, organic compound, or a metal oxide layer, having a physical thickness below 10 nanometers, preferably in a range of 2 to 5 nanometers. The medium layer 12 may include carbon (C), silicon (Si), or SiOₓ, where x can be either 1 or 2.

### Embodiments

The examples described below choose a polyethylene terephthalate (PET) substrate with two harden layers as a base. The PET substrate has a refractive index of approximately 1.43 and a thickness of 135 micrometers. The first visual light adjustment layer can be formed by a wet-coating process, and the second and third visual light adjustment layers, the transparent conductive layer, and the medium layer can be formed by a sputtering process, wherein the second visual light adjustment layer comprises titanium dioxide, the third visual light adjustment layer comprises silicon dioxide, the transparent conductive layer comprises indium tin oxide, and the medium layer comprises SiOₓ. The comparative examples also use a PET substrate with two harden layers as a base. The PET substrate of the comparative examples has a refractive index of about 1.43 and a thickness of 135 micrometers. The first and second buffer layers and the transparent conductive are formed using a sputtering process, wherein the first buffer layer comprises titanium dioxide, the second buffer layer comprises silicon dioxide, and the transparent conductive layer comprises indium tin oxide. The conditions and measured data of the embodiments and the comparative examples are listed in Table 1.

TABLE 1

| | | | | | | Comparative | Comparative | Comparative | Comparative | Comparative |
|---|---|---|---|---|---|---|---|---|---|---|
| | Example 1 | Example 2 | Example 3 | Example 4 | Example 5 | Example 1 | Example 2 | Example 3 | Example 4 | Example 5 |
| Medium | NA | NA | NA | NA | 2 nm | NA | NA | NA | NA | NA |
| layer SiOₓ | | | | | | | | | | |
| (physical | | | | | | | | | | |
| thickness) | | | | | | | | | | |
| First visual | 140 nm | 117 nm | 122 nm | 118 nm | 122 nm | NA | NA | NA | NA | NA |
| light | | | | | | | | | | |
| adjustment | | | | | | | | | | |
| layer | | | | | | | | | | |
| (optical | | | | | | | | | | |
| thickness) | | | | | | | | | | |
| Second | 14 nm | 17 nm | 19 nm | 19 nm | 19 nm | NA | NA | NA | NA | NA |
| visual light | | | | | | | | | | |
| adjustment | | | | | | | | | | |
| layer | | | | | | | | | | |
| (optical | | | | | | | | | | |
| thickness) | | | | | | | | | | |
| Third | 87 nm | 73 nm | 69 nm | 55 nm | 69 nm | NA | NA | NA | NA | NA |
| visual light | | | | | | | | | | |
| adjustment | | | | | | | | | | |
| layer | | | | | | | | | | |
| (optical | | | | | | | | | | |
| thickness) | | | | | | | | | | |
| ITO layer | 18 nm | 25 nm | 30 nm | 35 nm | 30 nm | 18 nm | 25 nm | 30 nm | 25 nm | 30 nm |
| (physical | | | | | | | | | | |
| thickness) | | | | | | | | | | |
| First buffer | NA | NA | NA | NA | NA | 14 | 15 | 15 | 65 | 60 |
| layer | | | | | | | | | | |
| (optical | | | | | | | | | | |
| thickness) | | | | | | | | | | |
| Second | NA | NA | NA | NA | NA | 79 | 73 | 55 | 63 | 58 |
| buffer layer | | | | | | | | | | |
| (optical | | | | | | | | | | |
| thickness) | | | | | | | | | | |
| Δa* | 0.01 | 0.11 | 0.1 | 0.1 | 0.1 | 0.21 | 0.42 | 0.1 | 1.59 | 2.89 |
| Δb* | 0.02 | 0.16 | 0.28 | 0.5 | 0.18 | 0.61 | 0.42 | 0.53 | 6.55 | 4.87 |
| ΔRᵣₘₛ (%) | 0.44 | 0.28 | 0.33 | 0.26 | 0.35 | 0.77 | 0.54 | 0.41 | 5.5 | 4.76 |
| ΔRₐᵥₑ (%) | 0.37 | 0.1 | 0.54 | 2.53 | 0.71 | 0.75 | 2.29 | 4.79 | 16.27 | 15.49 |
| VLT | 92.9 | 90.3 | 88.9 | 86.3 | 88.8 | 91.4 | 89.1 | 85.8 | 91.5 | 90.7 |
| Surface | 250 | 180 | 150 | 130 | 150 | 250 | 180 | 150 | 180 | 150 |
| resistance | | | | | | | | | | |
| (Ω/cm²) | | | | | | | | | | |

The Examples 1 to 5 are designed following the design principle of the present invention, and the experiment results are shown in Table 1. Each of Comparative Examples 1, 2, and 3 has merely two visual light adjustment layers designed in accordance with the design principle of the present invention. Comparative Examples 4 and 5 are conventionally designed to have low reflectance.

Δa* and Δb* are color differences of the entire transparent conductive laminate between before and after the TCL are patterned.

Comparative Examples 4 and 5 are prepared in accordance with the design for a conventional low reflectance optical film. Although the laminates of Examples 4 and 5 exhibit high visible light transmission (VLT), the color differences between before and after the TCL is patterned are great. As such, the laminates of Examples 4 and 5 cannot meet the requirements of capacitive or modified resistant touch panels.

Comparative Examples 1, 2, and 3 include two visual light adjustment layers designed in accordance with the design principle of the present invention. The experiment results show that when the surface resistance of a transparent conductive laminate is 180Ω/cm², the color difference Δa* is 0.42 and the color difference Δb* is 0.42 while the reflectance data, ΔRₐᵥₑ, is 2.29%, close to 3%. The color differences Δa* and Δb* are almost the same; however, the reflectance data, ΔRₐᵥₑ, tells that slight color differences can be perceived in the light reflected from the laminates of Comparative Examples 1, 2, and 3. Thus, the laminates merely including two visual light adjustment layers cannot satisfy the application that uses laminates with surface resistance of less than 180Ω/cm². The results of Examples 1, 2, and 3 show that when the surface resistance of a transparent conductive laminate is 150Ω/cm², the color differences Δa* and Δb* are almost the same, and the reflectance data, ΔRₐᵥₑ, is less than 1%. Compared with the laminates having only two visual light adjustment layers, the light transmission of the laminates made of Examples 1, 2, and 3 and having the same surface resistance over a visible wavelength range is 1.2% greater. In addition, the color differences Δa* and Δb* and the reflectance data, ΔRₐᵥₑ, are slightly different before and after the TCL is patterned. The result of Example 4 shows that when the surface resistance is 130Ω/cm², the color differences are small and the transmission over a visible wavelength range is high, around 86%. Example 5 includes a medium layer disposed between the organic polymer transparent substrate and the first visual light adjustment layer. Compared with those of Example 3, the optical properties of Example 5 show no obvious difference. The above experiment data obviously demonstrate that the laminates of the present invention are superior to conventional laminates.

The above-described embodiments of the present invention are intended to be illustrative only. Numerous alternative embodiments may be devised by persons skilled in the art without departing from the scope of the following claims.

What is claimed is:

1. A transparent conductive laminate, comprising:
an organic polymer transparent substrate;
a first visual light adjustment layer;
a second visual light adjustment layer;
a third visual light adjustment layer; and
a transparent conductive layer;
wherein the organic polymer transparent substrate, the first visual light adjustment layer, the second visual light adjustment layer, the third visual light adjustment layer, and the transparent conductive layer are sequentially stacked, and a surface resistance of the transparent conductive laminate ranges from 130 to 1000Ω/cm².

2. The transparent conductive laminate of claim 1, wherein the first visual light adjustment layer, the second visual light adjustment layer, and the third visual light adjustment layer adjust the transparent conductive laminate to have a root mean square deviation between a reflectance value over a wavelength range of from 380 nm to 700 nm and an average reflectance value over the wavelength range of from 380 nanometers to 700 nanometers is below 3%.

3. The transparent conductive laminate of claim 2, wherein the first visual light adjustment layer, the second visual light adjustment layer, and the third visual light adjustment layer adjust the transparent conductive laminate to have the root mean square deviation between the reflectance value over the wavelength range of from 380 nm to 700 nm and the average reflectance value over the wavelength range of from 380 nanometers to 700 nanometers is below 2%.

4. The transparent conductive laminate of claim 3, wherein the first visual light adjustment layer, the second visual light adjustment layer, and the third visual light adjustment layer adjust the transparent conductive laminate to have the root mean square deviation between the reflectance value over the wavelength range of from 380 nm to 700 nm and the average reflectance value over the wavelength range of from 380 nanometers to 700 nanometers is below 1%.

5. The transparent conductive laminate of claim 1, wherein the transparent conductive layer comprises metal oxide semiconductor.

6. The transparent conductive laminate of claim 5, wherein the transparent conductive layer comprises indium tin oxide, indium zinc oxide, aluminum zinc oxide, tin oxide, zinc oxide, and antimony-doped tin oxide.

7. The transparent conductive laminate of claim 5, wherein the transparent conductive layer has a refractive index of from 1.8 to 2.2 and an optical thickness of from 10 nanometers to 220 nanometers.

8. The transparent conductive laminate of claim 1, further comprising a medium layer disposed between the organic polymer transparent substrate and the first visual light adjustment layer, wherein the medium layer includes inorganic material, organic material, or metal oxide, and has a physical thickness of below 10 nanometers.

9. The transparent conductive laminate of claim 1, wherein the medium layer has a physical thickness of from 2 to 5 nanometers.

10. The transparent conductive laminate of claim 8, wherein the medium layer includes carbon, silicon, aluminum oxide or SiOₓ, where x is either 1 or 2.

11. The transparent conductive laminate of claim 1, wherein the transparent conductive layer includes a pattern portion and a hollow portion.

12. The transparent conductive laminate of claim 11, wherein an average reflectance difference between the pattern portion and the hollow portion over a range of from 380 nm to 800 nm is less than 3%.

13. The transparent conductive laminate of claim 12, wherein the average reflectance difference is less than 2%.

14. The transparent conductive laminate of claim 13, wherein the average reflectance difference is less than 1%.

15. The transparent conductive laminate of claim 11, wherein a difference value, Δa*, between the pattern portion and the hollow portion is less than 1, wherein a* is a coordinate value in the CIE L*a*b* system.

16. The transparent conductive laminate of claim 11, wherein a difference value, Δb*, between the pattern portion and the hollow portion is less than 1, wherein b* is a coordinate value in the CIE L*a*b* system.

17. The transparent conductive laminate of claim 1, wherein the organic polymer transparent substrate comprises poly(ethylene terephthalate) (PET), polyarylate (PAR), poly(ether sulfone) (PES), poly(ethylene naphthalate) (PEN), or polycarbonate.

18. The transparent conductive laminate of claim 1, wherein the organic polymer transparent substrate includes a harden layer or two harden layers.

19. The transparent conductive laminate of claim 1, wherein the first visual light adjustment layer includes a refractive index of from 1.3 to 1.7 and an optical thickness of from 10 nanometers to 260 nanometers; the second visual light adjustment layer includes a refractive index of from 1.8 to 2.5 and an optical thickness of from 3 nanometers to 1500 nanometers; and the third visual light adjustment layer includes a refractive index of from 1.3 to 1.7 and an optical thickness of from 10 nanometers to 260 nanometers.

20. The transparent conductive laminate of claim 1, wherein the first visual light adjustment layer and the second visual light adjustment layer comprise magnesium fluoride, silicon oxide (SiOₓ, where x is either 1 or 2), or aluminum oxide.

21. The transparent conductive laminate of claim 1, wherein the second visual light adjustment layer comprises cerium dioxide, titanium dioxide, niobium pentoxide, zirconium dioxide, or tantalum pentoxide (Ta₂O₅).
